(19) United States
(12) Patent Application Publication
(10) Pub. No.: US 2012/0067331 A1
(43) Pub. Date: Mar. 22, 2012

(54) Controlling engine braking loads using cat regeneration system (CRS)

(75) Inventors: John S. Pipis, JR., Washington, IL (US); Homa Afjeh, Peoria, IL (US)

(73) Assignee: Caterpillar Inc., Peoria, IL (US)

(21) Appl. No.: 12/883,226

(22) Filed: Sep. 16, 2010

(51) Int. Cl. F02B 33/00

(52) U.S. Cl. 123/564

(57) ABSTRACT

A power system comprising an engine, an intake air system, and an intake air bypass system. The intake air system delivers compressed air to the engine and the intake air bypass system diverts the compressed air away from the engine in response to the operation of an engine brake.

### TECHNICAL FIELD

The present disclosure relates to engine braking, and more particularly to engine intake air bypass systems used with engine braking systems.

### BACKGROUND

Engine systems often include an engine braking system to dissipate energy from the engine. Engine systems may also include an intake air bypass system that reroutes air away from the engine intake system. The air rerouted or diverted from the engine intake system may be used to supply air to a heat source used to regenerate a particulate filter in the exhaust.

United States Patent Publication No. 2008/0295485 discloses reducing the amount of diverted intake air used by the regeneration unit after a compression release engine brake has been active for a predetermined amount of time or if an engine overspeed condition is detected. U.S. Pat. No. 3,906,723 discloses avoiding air injection into the exhaust for the reduction of the unburnt gas components in the exhaust gases when an engine brake has been used for a long period of time. U.S. Pat. No. 7,644,584 discloses using an intake air bypass system when a variable geometry turbine is used to slow the engine.

### SUMMARY

In one aspect, a power system is disclosed comprising an engine, an intake air system, and an intake air bypass system. The intake air system delivers compressed air to the engine and the intake air bypass system diverts the compressed air away from the engine in response to the operation of an engine brake.

In another aspect, a method of reducing engine cylinder pressure during operation of an engine brake is disclosed. The method includes compressing air; delivering the compressed air to an engine; and diverting the compressed air away from the engine in response to operation of the engine brake.

In yet another aspect, a method of variably controlling the amount of retarding power from an engine is disclosed. The method includes operating an engine brake; compressing air; delivering the compressed air to an engine; and diverting the compressed air away from the engine in an amount to achieve a desired amount of retarding power.

Other features and aspects of this disclosure will be apparent from the following description and the accompanying drawings.

### BRIEF DESCRIPTION OF THE DRAWINGS

FIG. 1 is a diagrammatic view of a power system with an intake air bypass system and engine brake.

FIG. 2 is a diagrammatic cutaway view of an engine from FIG. 1.

FIG. 3 is a graph showing cylinder pressure and bypass valve position as a function of time.

FIG. 4 is a flow diagram of an intake air bypass control strategy.

FIG. 5 is a graph showing bypass valve position as a function of time.

FIG. 6 is a graph showing retarding power, engine brake level, and bypass valve position as a function of time.

### DETAILED DESCRIPTION

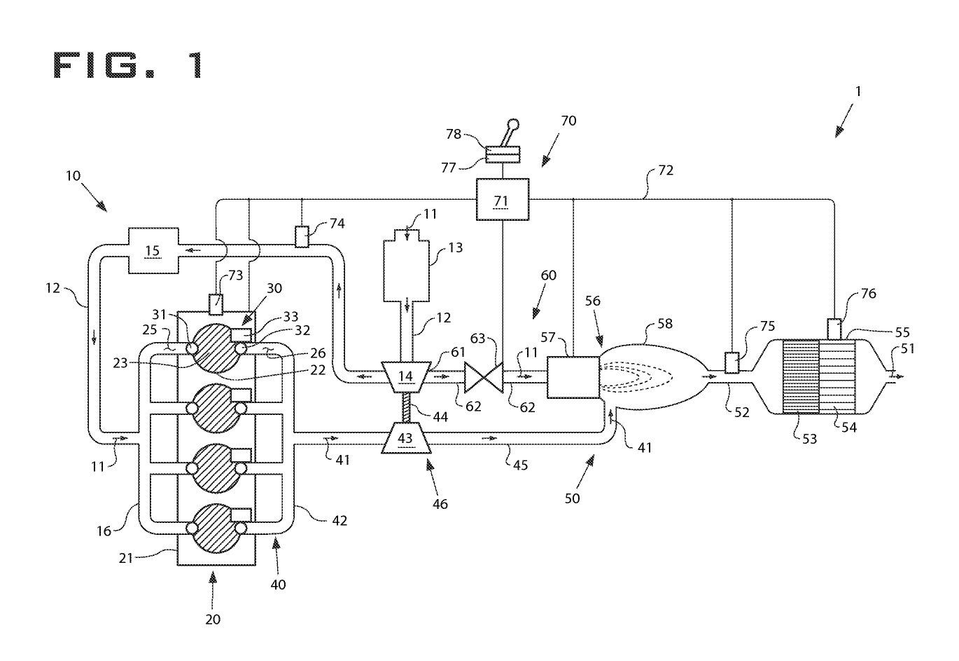

FIG. 1 illustrates an exemplary power system 1. The power system 1 includes an air intake system 10, an engine 20, an engine valve system 30, an exhaust system 40, an aftertreatment system 50, an intake air bypass system 60, and a control system 70. The power system 1 may be used to power any machine or other device, including on-highway trucks or vehicles, off-highway trucks, articulated trucks, earth moving equipment, mining equipment, generators, aerospace applications, locomotive applications, marine applications, pumps, stationary equipment, or other engine powered applications.

The air intake system 10 delivers fresh intake air 11 to the engine 20. The air intake system 10 includes an intake conduit 12, air cleaner 13, compressor 14, intake air cooler 15, and intake manifold 16. The fresh intake air 11 is sucked in through the intake conduit 12 and delivered to the engine 20. The intake air 11 is first drawn through the air cleaner 13, is then compressed by the compressor 14, and next cooled by the intake air cooler 15. The intake air 11 is then delivered to the engine 20 via the intake manifold 16. The air intake system 10 may also include an intake throttle valve to control the flow of intake air 11 and an intake air heater to warm the intake air 11 when needed.

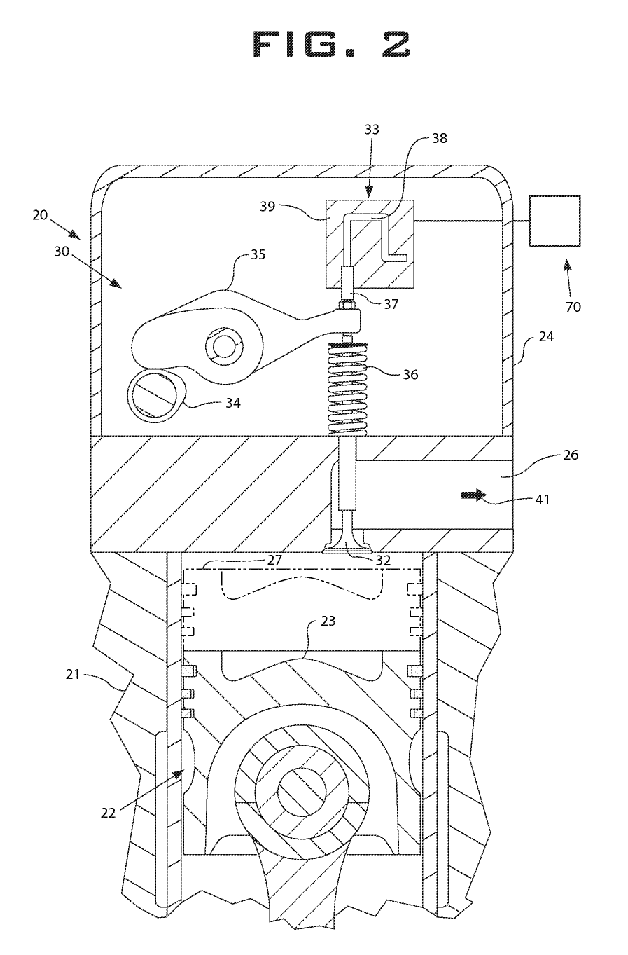

Referring now to both FIG. 1 and FIG. 2, the engine 20 includes a block 21, cylinders 22, pistons 23, valve cover 24, intake passages 25, exhaust passages 26, and a valve system 30. The valve system 30 includes intake valves 31, exhaust valves 32, engine brakes 33, cams 34, rockers 35, and springs 36. The intake air 11 is delivered to the cylinder 22 from the air intake system 10 through the intake passages 25 and intake valves 31. Fuel is then injected and combusts with the intake air 11 to cause the pistons 23 to reciprocate within the cylinders 22 to drive a crankshaft and create exhaust 41. The cams 34 rotate and cause the rockers 35 to pivot and move the intake valves 31 and exhaust valves 32. The intake and exhaust valves 31,32 are biased upward by the springs 36.

The engine brake 33 is used to dissipate energy in the engine 20 and provide retarding power. The engine brake 33 may be used with any machine, but is often used with fast moving machines. The engine brake 33 may be hydraulically operated, mechanically operated, electrically operated, pneumatically operated, or operated in any other suitable manner. The engine brake 33 may include hydraulically or electronically driven pistons or other actuators 37 and passageways 38 contained in a brake housing 39. In one embodiment, the engine brake 33 may be a compression release engine brake that works by actuating, opening, or controlling the exhaust valve 32. The actuator 37 opens the exhaust valve 32 independent of action from the cams 34 at near the top dead center position 27 of the piston 23 during the compression stroke, thereby releasing compressed air into the raw exhaust 41 and dissipating energy and slowing the machine.

In another embodiment, the engine brake 33 may be a constant-lift type engine brake 33. In such an arrangement, the engine brake 33 prevents exhaust valve 32 from fully closing, thereby maintaining the exhaust valve 32 in an open position at all or nearly all times.

The valve system 30 may also include an inlet valve actuation (IVA) device that controls the inlet valves 31. Of course the engine 20 may also include many other systems and elements not listed; such as fuel systems, sensors, cooling systems, peripheries, drivetrain components, exhaust gas recirculation systems, rings, liners, connecting rods, crankshafts, oil pans, oil pumps, flywheels, bearings, etc. The engine 20 may be any type of engine (internal combustion, gas, diesel, gaseous fuel, natural gas, propane, etc.), may be of any size, with any number of cylinders, and in any configuration (“V,” in-line, radial, etc.).

The exhaust system 40 routes the raw exhaust 41 from the engine 20 to the aftertreatment system 50. The exhaust system 40 includes an exhaust manifold 42, turbine 43, turbo shaft 44, and exhaust conduit 45. The compressor 14, turbine 43, and turbo shaft 44 together form a turbo 46. Raw exhaust 41 passes through the exhaust passage 26, into the exhaust manifold 42, and into the turbine 43. The turbine 43 is rotationally connected to the compressor 14 via the turbo shaft 44 and thus drives the compressor 14 by extracting energy from the hot exhaust 41. The exhaust conduit 45 delivers the raw exhaust 41 from the turbine 43 to the aftertreatment system 50. Some embodiments may also include one or more additional turbos in series or in parallel. Some embodiments may also include turbos with variable geometries, multiple asymmetric volutes, and/or wastegates.

The aftertreatment system 50 receives raw exhaust 41 and refines it to produce cleaned exhaust 51 that is routed to the atmosphere. Many variations to the aftertreatment system 50 are possible. Described below are a few possible arrangements.

The aftertreatment system 50 may include an exhaust conduit 52, a diesel oxidation catalyst (DOC) 53, and a diesel particulate filter (DPF) 54, which may be a catalyzed DPF 54. The DOC 53 and DPF 54 may be housed in a single canister 55, as shown, or individual canisters. A muffler may also be included in the aftertreatment system 50.

The DOC 53 oxidizes Carbon Monoxide (CO) and unburnt hydrocarbons (HC) into Carbon Dioxide (CO2). The DOC 53 includes a catalyst or precious metal coating on a substrate. The substrate may have a honeycomb or other elongated channel structure or other high surface area configuration. The substrate may be made from cordierite or another suitable ceramic or metal. The precious metal coating may consist mainly of Platinum, though other catalytic coatings may be used. The DOC 53 may also include a washcoat coating to help hold the precious metal coating and provide additional reaction sites.

The DPF 54 collects particulate matter (PM) or soot. The DPF 54 may also include a catalyst or precious metal and washcoat to help the DOC 53 with the oxidization of NO into Nitrogen dioxide (NO2). The catalyst of the DPF 54 is coated on a substrate with a honeycomb or other elongated channel or thin wall structure. The DPF 54 substrate may be more porous than the DOC 53 substrate and every other channel may be blocked with half the channels blocked at the inlet end and half blocked at the outlet end. This increased porosity and the blocked channels encourage wall flow of the exhaust. The wall flow causes the soot to be filtered and collected in the DPF 54.

The aftertreatment system 50 may also include a heat source 56 upstream of the DPF 54 for the regeneration or soot removal of the soot collected in the DPF 54. This regeneration requires an aftertreatment temperature above a light-off temperature of between 200 and 260 degrees Celsius in the DPF 54.

The heat source 56 may embody a burner including a combustion head 57 and a housing 58. The combustion head 57 may receive a supply of fuel and may also include an ignition source to generate a flame. The housing 58 may contain the flame and route the exhaust 41. In alternative embodiments the heat source 56 may not employ a fuel-fired burner. The heat source 56 may embody an electric heating element, microwave device, or other heat source. The heat source 56 may also embody operating the engine 20 under conditions to generate elevated exhaust 41 temperatures. Other embodiments may not include a heat source 56, the DPF 54 may be passively regenerated or the aftertreatment system 50 may not include a DPF 54.

The aftertreatment system 50 may also include a Selective Catalytic Reduction (SCR) system to reduce NO and NO2 into N2. The SCR system may include a SCR catalyst and reductant system to provide a supply of reductant, such as urea, to the SCR catalyst.

The intake air bypass system 60 diverts compressed intake air 11 from the intake system 10. The intake air bypass system 60 includes a bypass takeoff 61, bypass line 62, and a bypass valve 63. The bypass takeoff 61 may be on the compressor 14 or downstream of the compressor 14 in the intake system 10. The compressed intake air 11 is diverted from the bypass takeoff 61 and through the bypass line 62. The flow of compressed intake air 11 is controlled by the bypass valve 63 disposed in the bypass line 62.

In one embodiment, as shown in FIG. 1, the intake air bypass system 60 may deliver intake air 11 to the combustion head 57. The combustion head 57 may use the intake air 11 to aid in combustion. The intake air 11 may also be used to clean or purge components such as the heat source 56, fuel injector or ignition system. In other embodiments, the intake air bypass system 60 may deliver intake air 11 to the exhaust system 40, another portion of the aftertreatment system 50, anywhere downstream of the turbine 43, or directly to the atmosphere.

The control system 70 receives data from sensors, processes the data, and controls the operation of multiple components in the power system 1. The control system 70 includes a controller 71, wiring harness 72, and a plurality of sensors and other components. Some of the sensors may include an engine speed sensor 73, intake air pressure sensor 74, aftertreatment temperature sensor 75, and a DPF soot sensor 76. Other sensors may include an air intake temperature sensor, barometric pressure sensor, turbo speed sensor, EGR gas temperature sensor, EGR pressure or flow sensors, machine sensors, and many others. The sensors above may embody physical sensors or could be based on look-up tables or calculated or otherwise derived from other variables.

Some of the other components in the control system 70 may include an automatic engine brake control 77 and a manual engine brake control 78. The automatic engine brake control 77 may also be integrated into the controller 71. The manual engine brake control 78 allows the operator to select the level of engine braking.

The automatic engine brake control 77 may be configured to, when enabled, automatically engage the engine brake 33 to maintain a desired machine speed. For example, the automatic engine brake control 77 may be used during downhill travel of a machine to prevent the machine from speeding up. In another example, the automatic engine brake control 77 may also be used to assist the machine wheel brakes to slow the machine when the machine wheel brakes are applied by an operator, thereby helping prevent wear on the machine wheel brakes.

The sensors and components are all connected to the controller 71 via the wiring harness 72. The wiring harness 72 may also connect the controller 71 to the engine 20, bypass valve 63, heat source 56 and many other components. The controller 71 is configured or programmed to receive data from and control the components of the power system 1. The controller 71 may embody an electronic control module (ECM) or another processor capable of receiving, processing, and communicating the needed data. The controller 71 may also embody multiple units working together.

The soot sensor 76 provides an indication of the amount of soot loading in the DPF 54. The soot sensor 76 may embody a radio frequency (RF) sensor system, pressure sensor system, prediction model, or another method of measuring an amount of soot in the DPF 54.

The aftertreatment temperature sensor 75 provides an indication of the temperature in the aftertreatment system 50. The aftertreatment temperature sensor 75 may embody an aftertreatment inlet temperature sensor, a temperature sensor in another location, an extrapolation from engine maps, infrared temperature sensors, temperature sensors located upstream or downstream, or a correlation from pressure sensors.

### INDUSTRIAL APPLICABILITY

An intake air bypass control strategy 80 is disclosed wherein the intake air bypass system 60 is used in response to the activation or operation of the engine brake 33. This is in contrast to the prior art, which teaches away from using an intake air bypass system 60 during operation of the engine brake 33. The prior art discloses the intake air bypass system 60 being used independent from the engine brake 33, continuing after the engine brake 33 is activated, and stopping as a result of the engine brake 33 being operated.

Concerns about the operation of the regeneration unit, as described in United States Patent Publication No. 2008/0295485, may be resolved by disabling the heat source 56 while the engine brake 33 is on. Concerns about overheating of the exhaust in the aftertreatment system, as described in U.S. Pat. No. 3,906,723, may be resolved through the use of less catalytic material for passive regeneration of the DPF 54 and reliance on the heat source 56 to regenerate the DPF 54 or the use of components able to withstand the temperatures or a strategy that only uses the intake air bypass system 60 for a limited amount of time.

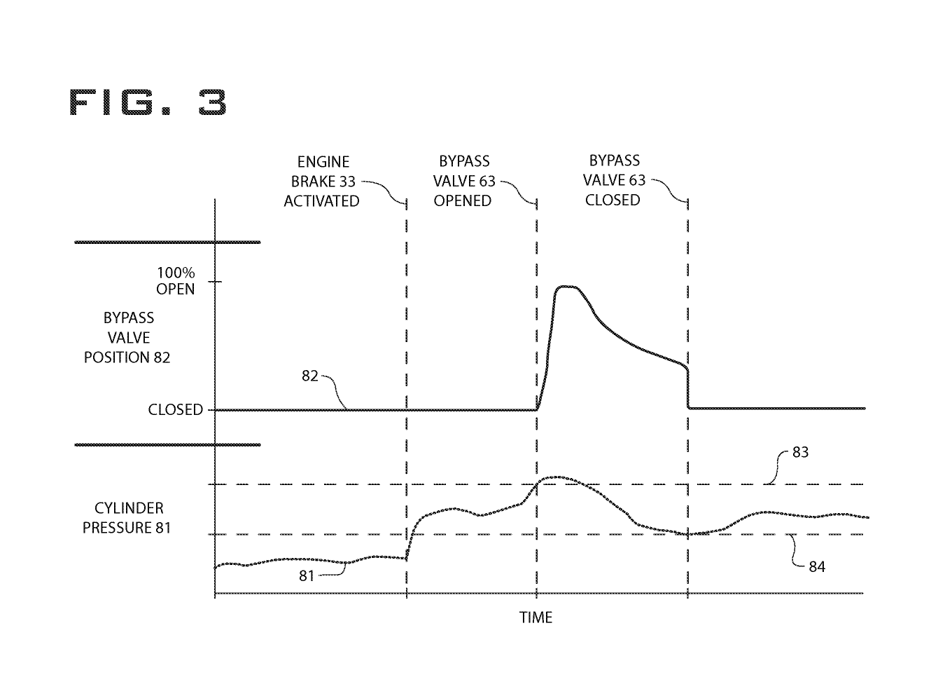

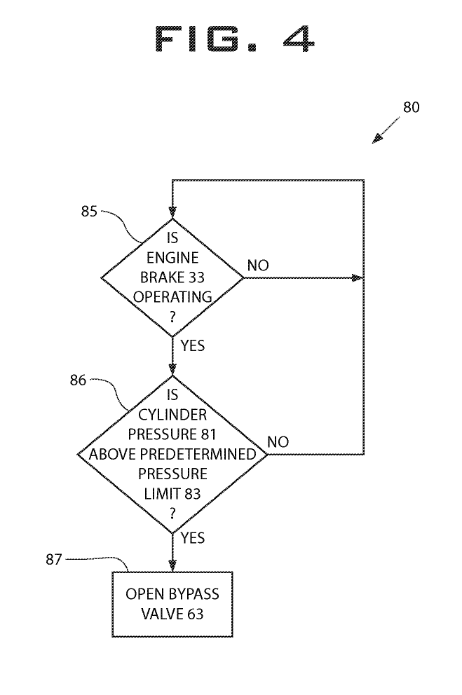

As shown in the graph of FIG. 3 and flowchart of FIG. 4, the intake air bypass control strategy 80 may be used to control cylinder pressure 81. High cylinder pressures 81 can place high levels of stress on the exhaust valves 32, rocker arms 35, brake actuators 37, and brake housing 39 that can harm performance or cause failures. High cylinder pressures 81 cause resistance to the opening the exhaust valve 32, placing a stress on the other components.

The cylinder pressure 81 may be estimated using a map or other means based on turbo 46 boost and engine speed. The turbo 46 boost may be based on the intake air pressure as provided by the intake air pressure sensor 74 and the engine speed may be determined by the engine speed sensor 73. The cylinder pressure 81 may also be directly measured or estimated from other variables. The intake air bypass control strategy 80 may also use another quantity as a proxy for cylinder pressure 81.

The graph in FIG. 3 illustrates how the intake air bypass control strategy 80 may be used to limit cylinder pressures 81. By opening the bypass valve 63, compressed air is robbed or diverted from the engine 20 and cylinder pressures 81 are reduced. FIG. 3 is an exemplary depiction with only general trends being shown. Actual rates of change and responses of the cylinder pressure 81 will vary.

FIG. 3 shows the cylinder pressure 81 plotted as a function of time and how the intake air bypass control strategy 80 controls the bypass valve position 82 in response. When the engine brake 33 is turned on or activated, the cylinder pressure 81 is expected to rise. Once the cylinder pressure 81 is above a predetermined activation limit 83 the bypass valve 63 is opened. FIG. 3 only shows one exemplary scenario and many others exist. In one other scenario the cylinder pressure 81 may have been above predetermined activation limit 83 already, before the engine brake 33 was activated.

The predetermined activation limit 83 may be assigned based on the given power system 1 and its components. In one embodiment, the predetermined activation limit 83 may be the cylinder pressure 81 that results in a brake housing 39 pressure of approximately 20-40 MPa.

The bypass valve 63 may be quickly moved to the 100% open position, as shown, or slowly opened, or opened to only a partially open position. The speed and degree the bypass valve 63 is initially opened may depend on the rate of change of the cylinder pressure 81.

The bypass valve 63 may not be fully closed until the cylinder pressure 81 has dropped below a predetermined deactivation limit 84 that is lower than the predetermined activation limit 83. The bypass valve 63 may be slowly closed as the cylinder pressure 81 decreases towards the predetermined deactivation limit 84. In some embodiments the predetermined deactivation limit 84 may be the same as the predetermined activation limit 83. Once the cylinder pressure 81 is below the predetermined deactivation limit 84, the bypass valve may not be opened again until after the predetermined activation limit 83 is again reached.

FIG. 4 illustrates a flow diagram of the intake air bypass control strategy 80. Step 85 checks to see if the engine brake 33 is on or operating. Step 86 checks to see if the cylinder pressure 81 is above the predetermined activation limit 83. Step 87 opens the bypass valve 63.

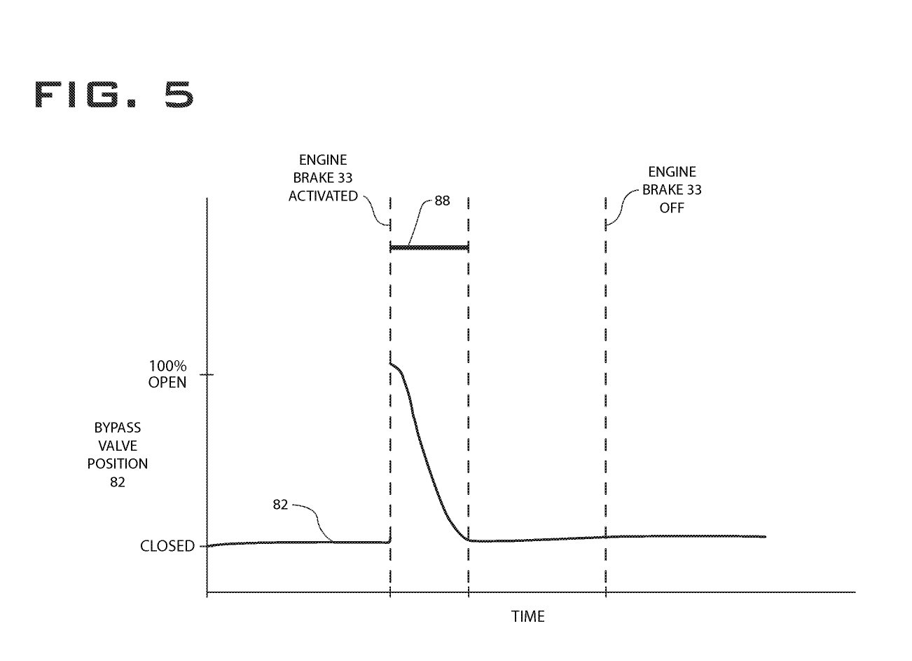

FIG. 5 is an exemplary depiction of how the intake air bypass control strategy 80 may also be used to control or smooth the cylinder pressure 81 during the activation of the engine brake 33. As discussed, activation of the engine brake 33 may cause cylinder pressures 81 to rise. This rise in cylinder pressures 81 may result in loud noise, vibration, or even cyclic fatigue of components. However, the intake air bypass control strategy 80 can be used during an initial period 88 of time after the engine brake 33 is turned on or activated to prevent a spike or fast rise in cylinder pressure 81. The bypass valve 63 may be opened once the engine brake 33 is activated and continually closed during the initial period 88. The bypass valve 63 may be moved to the 100% open or a less open bypass valve position 82 at the same time as the engine brake 33 is activated. The bypass valve 63 may also begin to be opened just before the engine brake 33 is activated. The bypass valve 63 may then be gradually moved back towards the closed position over the initial period 88.

The ability to smooth the increase in cylinder pressure 81 after the activation of the engine brake 33 may be particularly important when the automatic engine brake control 77 is used. The automatic engine brake control 77 may cause the engine brake 33 to be used more often than a manual system would, thereby increasing the number of cylinder pressure 81 spikes that would otherwise occur. The automatic engine brake control 77 may also activate the engine brake 33 at times when the operator is not expecting. The smoothing of the cylinder pressure 81 spike may increase the transparency of the engine brake's 33 operation causing less operator distraction.

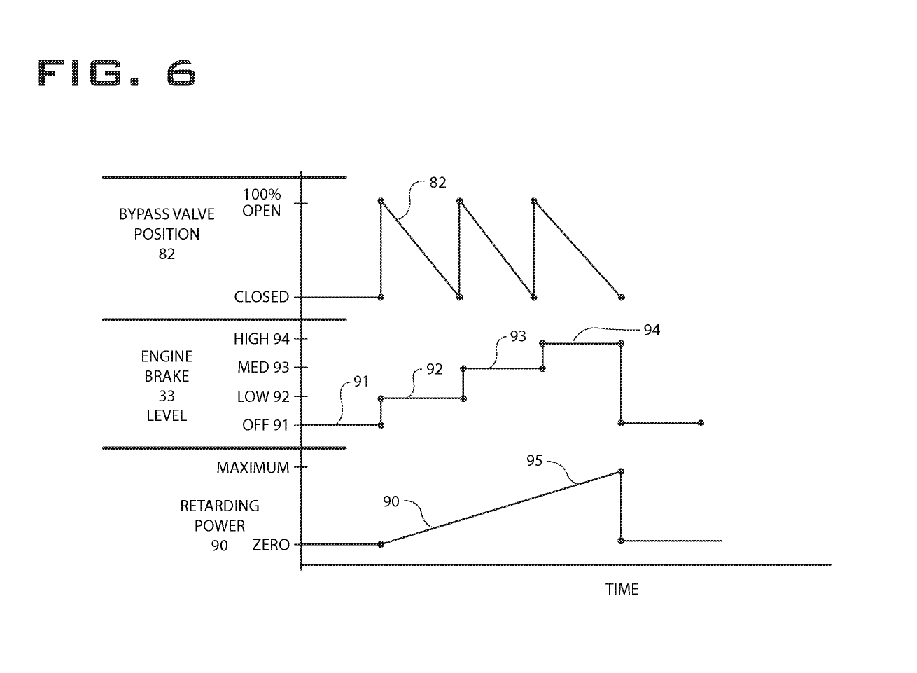

As seen in FIG. 6, the intake air bypass system 60 can also be used to control the level of engine braking or retarding level 90. The engine brake 33 may operate at discrete levels of braking; such as off 91, low 92, medium 93, and high 94. These levels of engine braking may be selected by the automatic engine brake control 77 or by the manual engine brake control 78. The selection of the different levels may correspond to the number of cylinders the engine brake 33 is operating on. Sometimes, the engine brakes 33 for groups of cylinders are tied together so that all the engine brakes 33 is either on or off for that whole group of cylinders. For example, on a 6 cylinder engine the engine brakes 33 for a group of 2 cylinders may be tied together. As a result, the low level 92 involves operation of 2 of the 6 cylinders, the medium level 93 involves operation of 4 of the 6 cylinders, and the high level 94 involves operation of all 6 cylinders. In other engines, the operation of the engine brake 33 for all cylinders may be tied together so there is the only level of engine braking and the engine brake 33 is either on or off.

Normally, these discrete levels of engine braking would cause discrete levels of retarding power 90. If the actual desired level of retarding power 90 were between two discrete levels the engine brake 33 may need to be turned off and on, the engine brake 33 may need to be changed back and forth from one level to another, the machine transmission may need to be shifted to change the engine speed, or the machine brakes may need to be applied.

As an aspect of the present disclosure, the intake air bypass system 60 may be used to create a variable retarding power 95 despite having the discrete levels of the engine brake 33. The ability for the operator or the automatic engine brake control 77 to variably select the level of retarding power 90 allows a better match between the retarding power 90 and the desired retarding power. The desired retarding power may be dependant on many factors: including power system 1 conditions, machine conditions, machine slope, machine payload, and terrain conditions.

By opening the bypass valve 63 the amount of retarding power 90 can be reduced. Accordingly, as seen in FIG. 6, the level of engine braking can be selected and the bypass valve position 82 opened and closed to achieve the variable retarding power 90 over a given range. FIG. 6 is an exemplary graph showing how the variable retarding power 95 may be achieved with the bypass valve position 82 and selection of engine brake 33 level. FIG. 6 shows linear relationships for simplicity. Linear changes in the bypass valve position 82 may not correspond to a linear change in retarding power 90 as shown. The required changes in bypass valve position 82 and engine brake level to achieve a desired level of retarding power 90 will have to be calibrated for each different power system 1.

As opposed to the discrete levels of engine braking, the variable retarding power 95 is nearly continuously variable or at least more variable than provided by the discrete levels. The use of the intake air bypass system 60 also widens the range of retarding power 90 available. Without the intake air bypass system 60 the lowest amount of retarding power 90 would be that retarding power 90 at the lowest level of engine braking. By opening the bypass valve 63, the range of retarding power 90 can be extended downward, possibly to as low as virtually zero.

With the variable retarding power 95, the need to turn the engine brake 33 off and on, change the engine braking level from one level to another, shift the machine transmission gear, or apply the machine brakes to maintain a desired machine speed may be reduced or eliminated. In one embodiment, this variable retarding power 95 may allow the operator to select the level of retarding they want with the manual engine brake control 78 instead of having to select between only a few discrete levels. The manual engine brake control 78 may now incorporate a continuously variable or multi-position dial or switch. In another embodiment, this variable retarding power 95 may allow the automatic engine brake control 78 to automatically select an amount of retarding power 90 needed to maintain the desired machine speed.

In an alternative embodiment, a back pressure valve may be disposed downstream of the turbine 43 to restrict the flow of exhaust 41. The restricted flow of exhaust 41 may cause a backup of pressure within engine 20 that increases the work the piston 23 must perform during the compression and exhaust strokes, thereby dissipating energy and slowing the machine. Accordingly, the backpressure valve could be used as a form of engine brake. The backpressure valve could also be used to raise exhaust temperatures and regenerate the DPF 54 or otherwise thermally manage the aftertreatment system 50. However, the backup of pressure within engine 20 caused by the backpressure valve may prevent the exhaust valve 32 from fully shutting (exhaust valve 32 floating). This condition can be especially problematic if it causes the piston 23 to come in contact with the exhaust valve 32. The intake air bypass system 60 could be used in response to the operation of the backpressure valve to reduce the backup of pressure in the engine 20 and prevent the amount of exhaust valve 32 floating that occurs.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A power system comprising:
an engine including an engine brake;
an intake air system configured to deliver compressed air to the engine; and
an intake air bypass system configured to divert the compressed air away from the engine in response to operation of the engine brake.

2. The power system of claim 1 wherein the intake air bypass system is configured to divert the compressed air away from the engine when a cylinder pressure in the engine is predicted to be above a predetermined limit.

3. The power system of claim 2 wherein:
the intake air system includes a compressor for compressing the air; and
the intake air bypass system includes:
a bypass takeoff from the compressor; and
a bypass valve fluidly connected to the bypass takeoff and configured to control the diversion of compressed air away from the engine.

4. The power system of claim 2 further including an exhaust system and wherein the intake air bypass system diverts compressed air to a heat source in the exhaust system.

5. The power system of claim 2 wherein the engine brake is a compression release engine brake configured to actuate an exhaust valve in the engine.

6. The power system of claim 1 wherein the intake air bypass system is configured to divert the compressed air away from the engine during an initial period of time after the engine brake is activated.

7. The power system of claim 1 wherein the intake air bypass system is configured to variably control an amount of retarding power at a discrete level of engine braking.

8. The power system of claim 1 wherein:
the intake air system includes a compressor for compressing the air; and
the intake air bypass system includes:
a bypass takeoff from the compressor; and
a bypass valve fluidly connected to the bypass takeoff and configured to control the diversion of compressed air away from the engine.

9. The power system of claim 8 wherein the bypass valve is opened once the engine brake is activated and then moved towards a closed position during an initial period of time.

10. The power system of claim 8 wherein the bypass valve is opened to achieve a variable amount of retarding power at a discrete level of engine braking.

11. The power system of claim 8 wherein the bypass valve is opened to extend a range of available retarding power.

12. A method of reducing engine cylinder pressure during operation of an engine brake comprising:
compressing air;
delivering the compressed air to an engine; and
diverting the compressed air away from the engine in response to operation of the engine brake.

13. The method of claim 12 wherein the diversion of the compressed air away from the engine is also in response to a cylinder pressure in the engine being predicted to be above a predetermined limit.

14. The method of claim 12 wherein the diversion of the compressed air away from the engine is during an initial period of time after the engine brake is activated.

15. The method of claim 12 wherein the engine brake is a compression release engine brake configured to actuate an exhaust valve in the engine.

16. The method of claim 12 wherein the diverted compressed air is delivered to a heat source in an exhaust system.

17. The power system of claim 12 wherein the engine brake is controlled with an automatic engine control system.

18. A method of variably controlling the amount of retarding power from an engine comprising:
operating an engine brake;
compressing air;
delivering the compressed air to the engine; and
diverting the compressed air away from the engine in an amount to achieve a desired amount of retarding power.

19. The method of claim 18 wherein the engine brake is operated at a level that would provide more than the desired amount of retarding power if no compressed air was diverted away from the engine.

20. The power system of claim 18 wherein the desired amount of retarding power is controlled with an automatic engine control system.
